(19) United States
(12) Patent Application Publication
(10) Pub. No.: US 2026/0200064 A1
(43) Pub. Date: Jul. 16, 2026

(54) BATTERY EXTENSION MODULAR ATTACHMENT SYSTEM FOR CORDLESS POWER TOOLS

(71) Applicant: Ethan J. Andersen, Bondurant, IA (US)

(72) Inventor: Ethan J. Andersen, Bondurant, IA (US)

(21) Appl. No.: 19/447,587

(22) Filed: Jan. 13, 2026

Related U.S. Application Data
(60) Provisional application No. 63/744,858, filed on Jan. 14, 2025.

(51) Int. Cl. B25F 5/00; H01M 50/258

(52) U.S. Cl. CPC B25F 5/00; H01M 50/258; H01M 2220/30

(57) ABSTRACT

Disclosed herein are various embodiments of a battery extension system that includes a housing that attaches to a cordless tool and its associated battery pack, and includes extensions to which accessory modules may be attached.

### CROSS-REFERENCE TO RELATED APPLICATION(S)

This application claims the benefit under 35 U.S.C. § 119(e) to U.S. Provisional Application 63/744,858, filed Jan. 13, 2025 and entitled “BATTERY EXTENSION MODULAR ATTACHMENT SYSTEM FOR CORDLESS POWER TOOLS,” which is hereby incorporated herein by reference in its entirety.

### FIELD

This disclosure relates to embodiments of devices, systems, and methods for attachment of modules to cordless power tools. In particular, certain such embodiments disclosed herein relate to devices and systems placed between a tool's battery receptacle and a removable battery pack, preserving electrical connection while offering a platform for modular attachments and tool specific accessories.

### BACKGROUND

Cordless power tools, such as drills and impact drivers, are essential for their portability and versatility. These tools rely on removable battery packs that connect directly to the tool, but this setup often lacks the flexibility to integrate accessories, such as bit holders, without modifying the tool or battery.

Different tool brands feature unique battery designs and latch mechanisms, making it difficult to create a universal solution for adding modular functionality. Users are often forced to rely on brand-specific options, limiting compatibility and adaptability.

The present invention introduces an intermediary device placed between a cordless power tool and its battery pack. The system features a brand-specific base to fit varying tool designs while providing standardized modular attachments, such as bit holders, compatible across all versions. This solution enhances the functionality of cordless tools without altering their original design or power delivery.

### BRIEF SUMMARY

Discussed herein are various embodiments of a battery extension system that includes a housing that attaches to a cordless tool and its associated battery pack, and includes extensions to which accessory modules may be attached.

In Example 1, a battery extension modular attachment system comprises a housing configured for placement between a cordless power tool and a removable battery pack, an upper connector on the housing adapted to mate with a battery port of the cordless power tool, a lower connector on the housing adapted to mate with the removable battery pack, an internal conductive pathway within the housing maintaining uninterrupted electrical connectivity between the battery pack and the cordless power tool, and an attachment interface on the housing for receiving modular accessories.

Example 2 relates to the battery extension modular attachment system according to Example 1, wherein the housing includes side attachment extensions having attachment elements configured to operably couple to one or more side modules.

Example 3 relates to the battery extension modular attachment system according to Example 1, wherein the lower connector includes a quick-release latch for securing the removable battery pack.

Example 4 relates to the battery extension modular attachment system according to Example 1, wherein the internal conductive pathway comprises spring-loaded terminals and electrical receptacles configured to mimic conductive elements of the cordless power tool and the battery pack.

Example 5 relates to the battery extension modular attachment system according to Example 1, wherein the housing is formed from a glass-filled nylon material.

Example 6 relates to the battery extension modular attachment system according to Example 1, wherein the attachment interface comprises threaded inserts for accessory mounting.

Example 7 relates to the battery extension modular attachment system according to Example 1, wherein the attachment interface comprises a plurality of dovetail connections.

Example 8 relates to the battery extension modular attachment system according to Example 1, wherein the attachment interface comprises a ball and spring.

Example 9 relates to the battery extension modular attachment system according to Example 1, wherein the housing further comprises electronic circuitry for monitoring tool usage.

Example 10 relates to the battery extension modular attachment system according to Example 1, wherein the housing includes a sensor for detecting motion or orientation.

In Example 11, a modular intermediary system for cordless power tools comprises a housing having a first connector adapted to engage a battery port of a cordless power tool and a second connector adapted to engage a removable battery pack, an electrical continuity assembly within the housing configured to transmit power from the battery pack to the cordless power tool, and a pair of side attachment extensions on the housing including attachment elements for coupling to one or more side modules.

Example 12 relates to the modular intermediary system according to Example 11, wherein the attachment elements comprise dovetail joints configured to resist sliding movement under normal use.

Example 13 relates to the modular intermediary system according to Example 12, wherein the dovetail joints include one or more tails on the side module and corresponding sockets on the housing.

Example 14 relates to the modular intermediary system according to Example 13, wherein the dovetail joints include a stop configured to prevent downward movement of the side module relative to the housing.

Example 15 relates to the modular intermediary system according to Example 11, wherein the attachment elements further include a ball-and-spring locator configured to engage an aperture on the side module to prevent unwanted sliding movement.

Example 16 relates to the modular intermediary system according to Example 11, wherein the side module includes a magnetic pad and bit apertures oriented vertically, horizontally, or adjustably.

In Example 17, a cordless power tool accessory platform comprises a housing configured to be positioned between a cordless power tool and a removable battery pack, connectors on opposing ends of the housing for electrically coupling the cordless power tool to the removable battery pack, and an attachment interface disposed on an exterior surface of the housing, the attachment interface adapted to secure at least one accessory module, wherein the housing maintains uninterrupted electrical connectivity between the cordless power tool and the removable battery pack.

Example 18 relates to the cordless power tool accessory platform according to Example 17, wherein the attachment interface comprises a dovetail joint for accessory module engagement.

Example 19 relates to the cordless power tool accessory platform according to Example 18, wherein the dovetail joint includes a stop configured to prevent downward movement of the accessory module relative to the housing.

Example 20 relates to the cordless power tool accessory platform according to Example 17, wherein the housing includes a ball-and-spring locator for securing the accessory module in a desired position.

While multiple embodiments are disclosed, still other embodiments will become apparent to those skilled in the art from the following detailed description, which shows and describes various illustrative implementations. As will be realized, the various embodiments herein are capable of modifications in various obvious aspects, all without departing from the spirit and scope thereof. Accordingly, the drawings and detailed descriptions are to be regarded as illustrative in nature and not restrictive.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1A is a perspective view of a cordless tool, according to one embodiment.

FIG. 1B is a perspective view of the cordless tool of FIG. 1A with the battery pack detached, according to one embodiment.

FIG. 2A is an underside view of the battery port of the cordless tool of FIG. 1A, according to one embodiment.

FIG. 2B is a perspective view of a battery pack of the cordless tool of FIG. 1A, according to one embodiment.

FIG. 2C is a perspective view of a battery pack of the cordless tool of FIG. 1A, according to one embodiment.

FIG. 3A is a perspective view of a cordless tool with an attachment system attached thereto, according to one embodiment.

FIG. 3B is an exploded perspective view of the cordless tool of FIG. 3A, according to one embodiment.

FIG. 4A is an exploded perspective view of the attachment system, according to one embodiment.

FIG. 4B is a perspective view of the attachment system of FIG. 4A attached to a cordless tool, according to one embodiment.

FIG. 4C is a cross section of a housing of the attachment system of FIG. 4A highlighting the conductive elements of the internal conductive pathway within the housing, according to one embodiment.

FIG. 4D is a cross section of a housing of the attachment system of FIG. 4A highlighting the electrical receptacles of the internal conductive pathway within the housing, according to one embodiment.

FIG. 5A is a perspective view of an attachment module detached from the housing of the attachment system of FIG. 4A, according to one embodiment.

FIG. 5B is a perspective view of an attachment module detached from the housing of the attachment system of FIG. 4A, according to one embodiment.

FIG. 6A is an underside view of the battery port of the cordless tool of FIG. 1A highlighting the common elements between the attachment system and the battery port, according to one embodiment.

FIG. 6B is an isometric view of a housing of an attachment system, according to one embodiment.

FIG. 6C is an isometric view of the housing of the attachment system of FIG. 6B, according to one embodiment.

### DETAILED DESCRIPTION

The various device and system embodiments disclosed or contemplated herein include certain aspects of a battery extension attachment system for cordless tools. The purpose of certain of these embodiments is to enable various enhancements, modifications, and additions to cordless power tools without requiring permanent alterations to the tool or the battery pack.

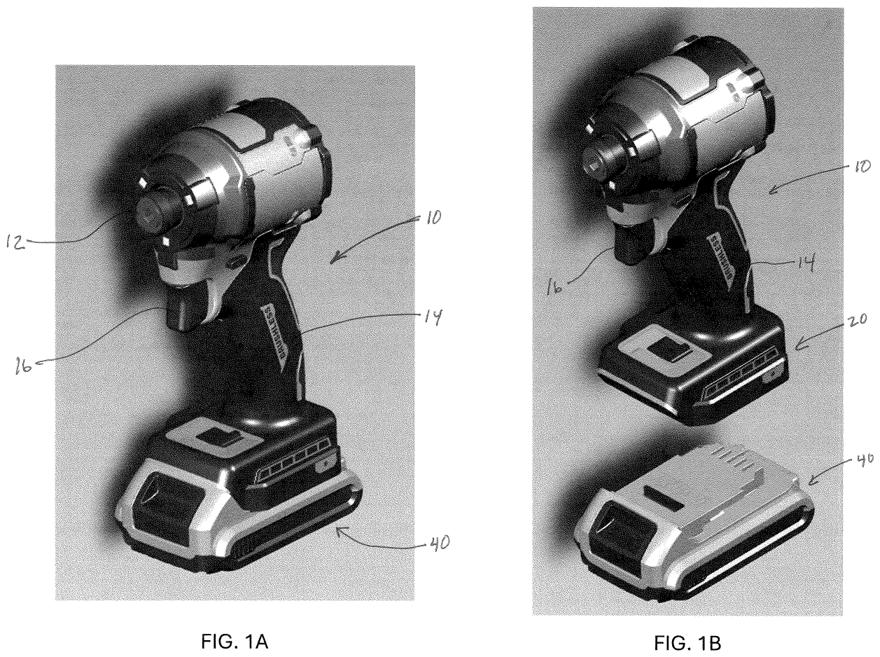

FIGS. 1A and 1B show an isometric view of a typical cordless power tool 10, which in the exemplary and non-limiting embodiments described below is a cordless drill. The cordless power tool may be any cordless tool and include any working end 12 such as a drill, impact wrench, screwdriver, hammer drill, circular saw, reciprocating saw, jigsaw, angle grinder, oscillating multi-tool, rotary tool, nail gun, stapler, heat gun, caulking gun, planer, router, sander, wet/dry vacuum, air compressor, string trimmer, hedge trimmer, leaf blower, chainsaw, or any other cordless battery-operated tool known in the art. The power tool 10 includes the tool 12 and a battery pack 40. The battery pack is rechargeable on an external charger, and provides the electrical power necessary to power the tool 10. Typically, the battery pack 40 is selectively attachable (shown attached in FIG. 1A) and detachable (shown detached in FIG. 1B) from the tool 12 at a convenient battery port location 20 on the tool 12, which depends on the type of tool being used.

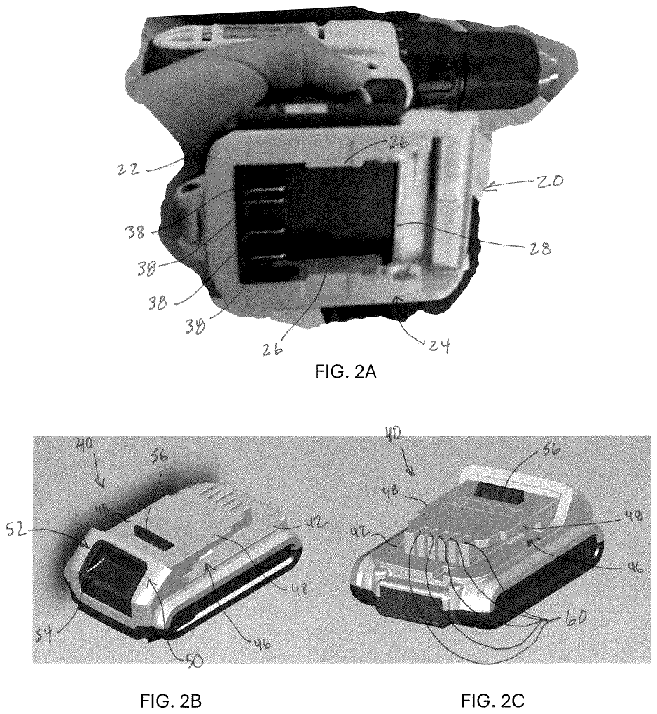

As best shown in FIG. 2A, in some embodiments, the tool 10 includes a battery port 20 having a base 22 and a battery interface 24 with side flanges 26, a locking flange 28, and one or more conductive elements 38. As best shown in FIGS. 2B-2C, the battery pack includes a base 42 with the battery element 44 therewithin, and a tool interface 46 that corresponds to the battery interface 24 of the tool 10. The tool interface 46 of the battery pack 40 includes side flanges 48, a locking feature 50 with a lever 52 having a push button 54, a locking end 56, and a spring 58 inside the base 42, and electrical receptacles 60 configured to mate with the conductive elements 30 on the tool 12 such that electrical power is transferred from the battery 44 to the working end 12 of the cordless tool 10.

The interface of the battery pack 40 with the tool 10 is best shown in FIGS. 2A-2C. It should be known that the interface of the non-limiting example embodiment of FIGS. 2A-2C between the battery pack 40 and the cordless tool 10 is a “slide-and-lock” type interface, whereby the battery pack 40 slides into place on the cordless tool with side flanges 26 on the tool 10 operably interfacing with corresponding side flanges 48 on the battery pack, allowing for sliding motion but not allowing vertical removal of the battery pack 40 from the tool 10. As the user slides the battery pack from an insertion position to the locked and/or in-use position, a locking feature 28 of the cordless tool 10 interfaces with the locking feature 56 of the battery pack 40 and holds the battery pack in place on the tool. This ensures that electrical receptacles 60 on the battery pack mate with conducting elements 38 on the cordless tool 10 and provides an electrical circuit from the battery 44, through the electrical receptacles 60, to the conductive elements 38, and therethrough to the working end 12 of the cordless tool 10. The slide-and-lock interface is but one of many different battery interface types, any of which may be used without deviating from the scope of the disclosure.

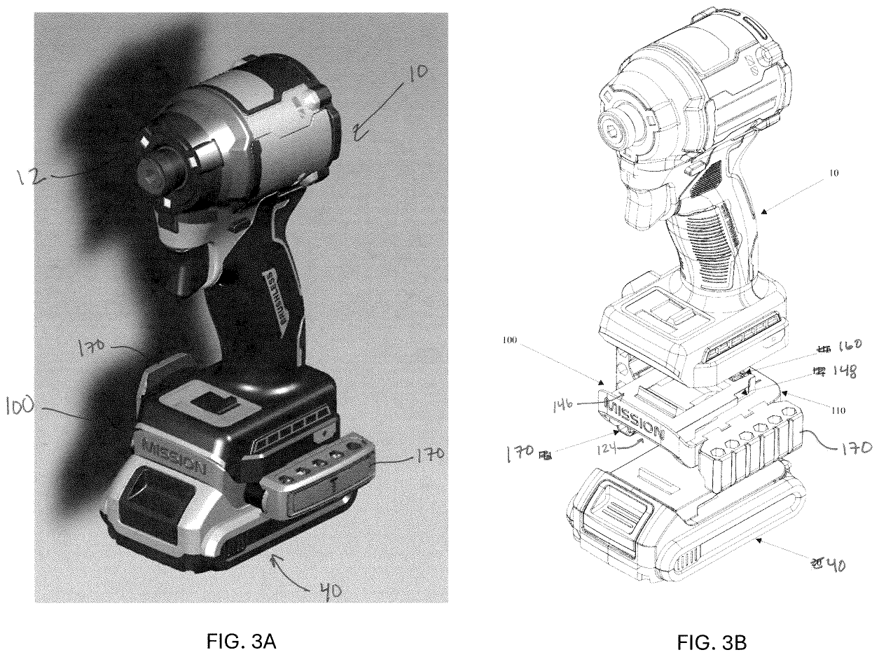

An embodiment of the battery extension modular attachment system 100 (also referred to herein as the “attachment system”) is best shown in position on the cordless tool 10 in FIGS. 3A and 3B. Generally speaking, the attachment system 100 mimics the tool interface 46 on one side and the battery interface 24 on another side. It should be known to those skilled in the art that the slide-and-lock battery port scheme shown in the embodiments herein is one of many different battery port schemes that may be mimicked by the attachment system 100 without deviating from the scope of the disclosure. In some embodiments, the attachment system 100 includes a housing 110 with a battery interface 124 and a tool interface 146 that mimic the battery interface 24 of the cordless tool 10 and the tool interface 46 of the battery pack 40, respectively. This allows for the system 100 to attach to the existing battery port 20 of the cordless tool 10 and receive and lock the existing battery pack 40.

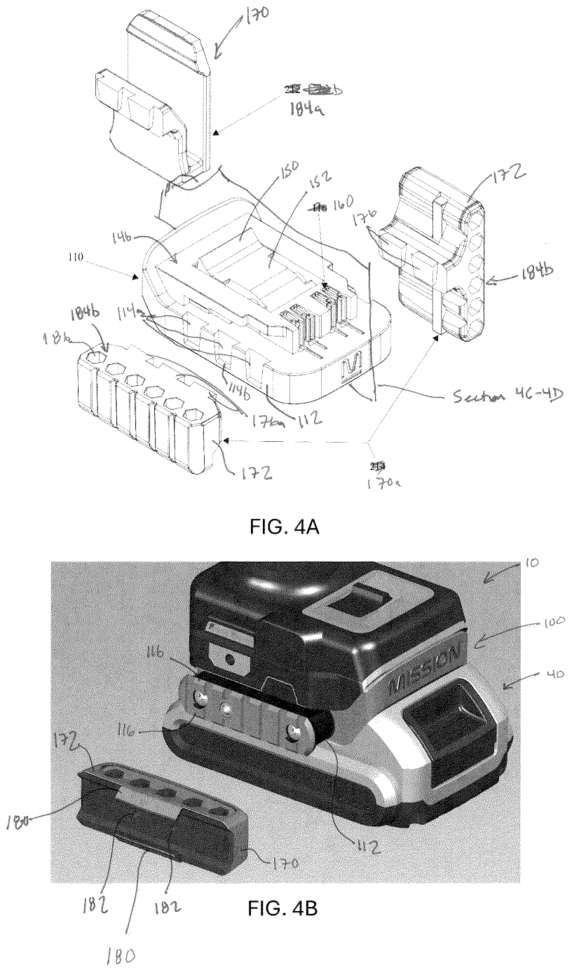

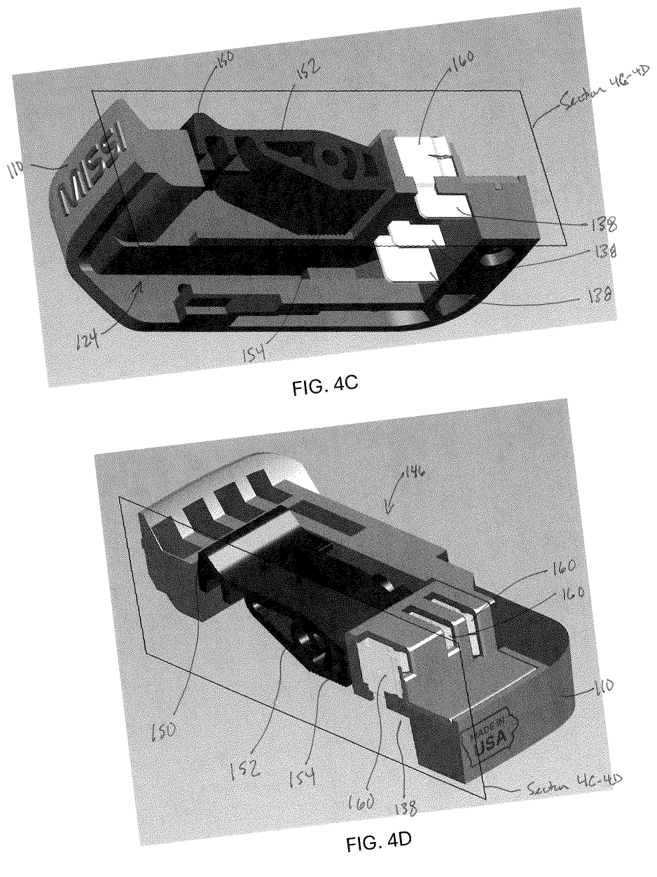

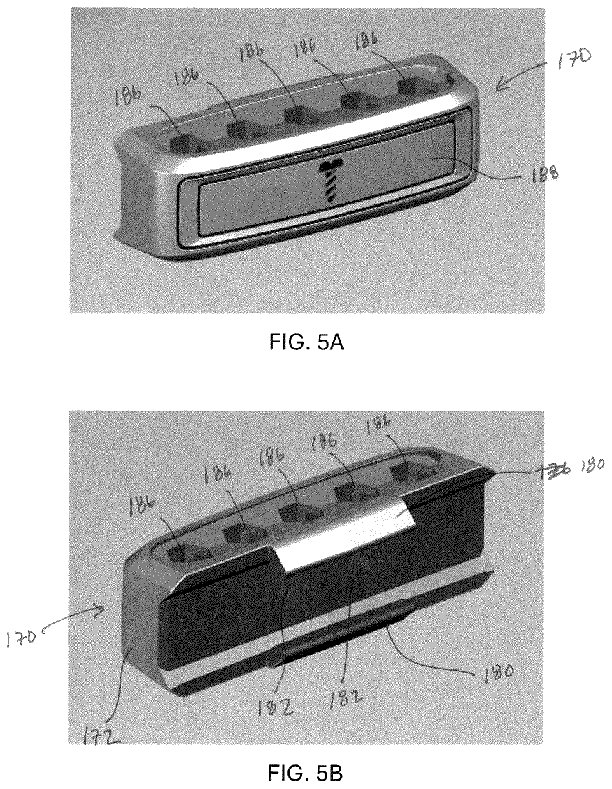

As best shown in FIGS. 4A-4B, in some embodiments, the housing 110 of the system 100 includes side attachment extensions 112 (in some embodiments extending from the base 110 as shown in FIG. 4B, and in other embodiments relatively flush with the sides of the housing 110 as shown in FIG. 4A) having attachment elements 114 configured to operably couple to one or more side modules 170 as will be described in more detail below. The side attachment extensions 112 allow for the user to attach and detach the side modules 170 and keep handy any number of attachments or bits for use with the working end 12 of the tool 10. In certain of these embodiments, tool modules 170 have attachment elements 176 that correspond to the attachment elements 114 on the housing 110 of the system 100.

As best shown in FIG. 4A, in some embodiments the attachment elements 114 and 176 on the housing 110 and one or more of the tool modules 170 include corresponding dovetail elements such as one or more tails 176a on the module 170 that operably couple to corresponding sockets 114a on the housing 110. A user inserts the tails 176a into the sockets 114a on the sides of the housing 110 until it reaches a stop 114b. In normal use, gravity will urge the module 170 downwardly against the stop 114b, while the interfering faces of the tails 176a and the sockets 114a keep the module 170 from being pulled outwardly from the housing 110 and away from the tool 10. Friction between the elements 114 and 176 will also work to resist sliding movement unless and until a user overcomes the friction to slide the module 170 onto or out of the housing 110.

It should be known to one or ordinary skill that the number of tails and sockets in such an arrangement may be 1, 2, 3 (as shown), 4, 5, or more interface elements, depending on the specific use case without deviating from the scope of the disclosure. In still other embodiments, the tails and sockets may be reversed such that the sockets and the stop are on the module 170, and the tails are on the housing 110 without deviating from the scope of the disclosure. In still other embodiments, a dovetail joint that relies solely on friction may be utilized without using a stop.

In still other embodiments as best shown in FIG. 4B, the module or modules 170 may be attached or operably coupled to the housing 110 by a sliding and stop mechanism. In such embodiments, the housing 100 may include side extensions 112 that have a holding flange 116 extending upwardly and downwardly (with respect to the directions shown in FIG. 4B) therefrom. In such embodiments, the module or modules 170 include restraining flanges 180 that reach to the opposite side (away from the side module 170) of the holding flange 116 and prevent the side module 170 from being removed from the system 100 outwardly (away from the housing 110). In some embodiments, the side extension 112 is held onto the housing by fasteners 120. In still other embodiments, the side extension 112 is formed integrally with the housing 110.

In some embodiments, the friction between the module 170 and the side extension 112 is designed such that that the module 170 will not slide on the side extension under normal use. In such embodiments, only when a user desires to attach or detach the side module 170 and pushes the side module 170 with enough force to overcome the friction between the side module 170 and the side extension 112 will the side module be removed from the housing 110. In other embodiments, as best shown in FIG. 4B, one or more ball and spring locators 118 may be used to prevent unwanted sliding movement. In such embodiments, the ball is urged outwardly by the spring, and is forced inwardly as the side module 170 (shown reversed in FIG. 4B to show the interface) is slid onto the side extension 112 of the housing 110. One or more ball apertures 182 may be located on the side module 170, at least one of which lines up with at least one of the balls when the side module is located at the desired location. The ball extends into the ball aperture, which prevents further sliding movement until a user increases the sliding force on the side module to overcome the increased holding force exerted on the side module from the spring onto the ball and into the ball aperture 182.

In some embodiments, the housing 110 of the system 100 is formed from a durable material (e.g., glass-filled nylon, polymer resin) to withstand typical job-site conditions. On an upper connector (upper in this embodiment as toward the cordless tool 10) or a tool interface 146, the housing 110 mates with the battery port 20 of the tool 10, while on a lower connector (lower in this embodiment as toward the battery pack 40) or battery interface 124, it mates with a removable battery pack 20. Inside the housing 110, conductive elements 130 (e.g., spring-loaded terminals) maintain uninterrupted electrical contact from the battery pack 40 to the power tool 10.

Looking back at FIG. 4A and shown in 5A-5B, a variety of potential accessories 184 are shown that can be attached to the housing 110 via the side modules 170. These accessories 184 may include, but are not limited to, hooks 184a for hanging the power tool and magnetic drill or driver bit holders 184b for on tool storage. In such embodiments, the bit holders 184b may include bit apertures 186 that may be oriented vertically, horizontally, or may be adjustable such that the user may change the orientation as desired. The side module 170 may further include a magnet 188 onto which loose elements such as nails, screws, or any other type of loose metallic elements may be securely attached but easily accessed.

While the system 100 as shown is designed to attach to the slide-and-lock battery system described, it should be known that the system may accommodate different battery profiles, latch mechanisms, and voltage ranges. In some embodiments, the housing 110 can incorporate sensors or electronic control circuitry (e.g., for motion sensing or usage). In such embodiments, these additions rely on the direct electrical access provided by the housing's position between the power tool 10 and the battery pack 40.

As best shown in the cross-sections of FIGS. 4C-4D, the system 100 includes an internal conductive electrical pathway for electrical power from the battery 44 to connect to the working end 12 of the tool 10. In some embodiments, the housing 110 of the system 100 includes substantially similar elements to the conductive elements 38 on the battery port 20 of the tool 10 and the electrical receptacles 60 on the battery pack 40. In such embodiments, the conductive elements 138 on the housing mimic the conductive elements 38, and the electrical receptacles 160 mimic the electrical receptacles 60. As shown, the electrical receptacles are C-clamp or spring-loaded terminal type connectors or receptacles, but it should be known that any other type of receptacle or connection is contemplated without deviating from the scope of the disclosure.

The conductive elements 138 and the electrical receptacles 160 are electrically commutatively coupled such that when the housing 110 of the system 100 is in place on the tool 10 and the battery pack 40 attached thereto, the electrical power from the battery pack 40 reaches from the electrical receptacles 60, to the conductive elements 138, to the electrical receptacles 160, and then to the conductive elements 38 as if the system 100 was not there.

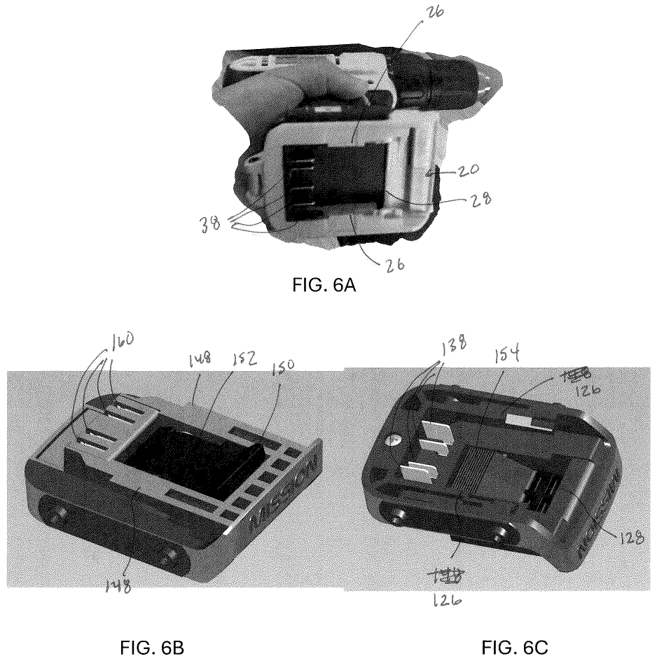

To install the system 100, a user detaches the battery pack 40 from the power tool 10 (like shown in FIG. 1A to 1B) and aligns the housing 110 with the power tool's battery port 20 so that the tool interface 146 securely latches thereto. In the embodiment as best shown in FIGS. 6A to 6C, this is accomplished by sliding side flanges 148 of the housing 110 under the side flanges 26 of the battery interface 24 of the tool 10 until the locking end 156 of the lever 152 slides over and interferes with the locking feature 28 of the battery port 20. Next, the side flanges 48 of the battery pack 40 are slid under the side flanges 126 on the battery interface 124 of the housing 110, until the locking feature 50 of the battery pack 40 interferes with the locking flange 128 of the battery interface 124 of the housing 110. In this way.

To remove the housing 110 from the tool 10, the button 54 on the lever 52 is pushed, removing the interference between the locking end 56 and the locking feature 128 of the housing 110, and the battery pack 40 may be slid out from the housing 110. Then, the button 154 on the lever 152 is pushed, removing the interference between the locking end 156 and the locking feature 28 of the battery port 20 of the tool 10, and the housing 110 may be slid out from the tool 10.

Variations in shape, size, and connector styles can be made to suit other cordless tools, including drills, saws, and other battery-operated equipment. The principle remains an intermediary system that mimics the attachment scheme of a battery to a cordless tool and preserves electrical flow while enabling a modular interface for accessories.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A battery extension modular attachment system for cordless power tools, comprising:
(a) a housing configured for placement between a cordless power tool and a removable battery pack;
(b) an upper connector on the housing adapted to mate with a battery port of the cordless power tool;
(c) a lower connector on the housing adapted to mate with the removable battery pack;
(d) an internal conductive pathway within the housing maintaining uninterrupted electrical connectivity between the battery pack and the cordless power tool; and
(e) an attachment interface on the housing for receiving modular accessories.

2. The battery extension modular extension system of claim 1, wherein the housing includes side attachment extensions having attachment elements configured to operably couple to one or more side modules.

3. The battery extension modular extension system of claim 1, wherein the lower connector includes a quick-release latch for securing the removable battery pack.

4. The battery extension modular extension system of claim 1, wherein the internal conductive pathway comprises spring-loaded terminals and electrical receptacles configured to mimic conductive elements of the cordless power tool and the battery pack.

5. The battery extension modular extension system of claim 1, wherein the housing is formed from a glass-filled nylon material.

6. The battery extension modular extension system of claim 1, wherein the attachment interface comprises threaded inserts for accessory mounting.

7. The battery extension modular extension system of claim 1, wherein the attachment interface comprises a plurality of dovetail connections.

8. The battery extension modular extension system of claim 1, wherein the attachment interface comprises a ball and spring.

9. The battery extension modular extension system of claim 1, wherein the housing further comprises electronic circuitry for monitoring tool usage.

10. The battery extension modular extension system of claim 1, wherein the housing includes a sensor for detecting motion or orientation.

11. A modular intermediary system for cordless power tools, comprising:
(a) a housing having a first connector adapted to engage a battery port of a cordless power tool and a second connector adapted to engage a removable battery pack;
(b) an electrical continuity assembly within the housing configured to transmit power from the battery pack to the cordless power tool; and
(c) a pair of side attachment extensions on the housing including attachment elements for coupling to one or more side modules.

12. The modular intermediary system of claim 11, wherein the attachment elements comprise dovetail joints configured to resist sliding movement under normal use.

13. The modular intermediary system of claim 12, wherein the dovetail joints include one or more tails on the side module and corresponding sockets on the housing.

14. The modular intermediary system of claim 13, wherein the dovetail joints include a stop configured to prevent downward movement of the side module relative to the housing.

15. The modular intermediary system of claim 11, wherein the attachment elements further include a ball-and-spring locator configured to engage an aperture on the side module to prevent unwanted sliding movement.

16. The modular intermediary system of claim 11, wherein the side module includes a magnetic pad and bit apertures oriented vertically, horizontally, or adjustably.

17. A cordless power tool accessory platform, comprising:
(a) a housing configured to be positioned between a cordless power tool and a removable battery pack;
(b) connectors on opposing ends of the housing for electrically coupling the cordless power tool to the removable battery pack; and
(c) an attachment interface disposed on an exterior surface of the housing, the attachment interface adapted to secure at least one accessory module;
wherein the housing maintains uninterrupted electrical connectivity between the cordless power tool and the removable battery pack.

18. The cordless power tool accessory platform of claim 17, wherein the attachment interface comprises a dovetail joint for accessory module engagement.

19. The cordless power tool accessory platform of claim 18, wherein the dovetail joint include a stop configured to prevent downward movement of the accessory module relative to the housing.

20. The cordless power tool accessory platform of claim 17, wherein the housing includes a ball-and-spring locator for securing the accessory module in a desired position.
